(19) United States
(12) Patent Application Publication
(10) Pub. No.: US 2011/0078728 A1
(43) Pub. Date: Mar. 31, 2011

(54) METHOD AND MEANS FOR PROVIDING ELECTRONIC PROGRAM GUIDE AND A METHOD AND MEANS FOR POSTING AND PRESENTING ADVERTISEMENT

(75) Inventors: Gang Fu, Shanghai (CN); Xin Yao, Shanghai (CN); Kun Wang, Shanghai (CN)

(73) Assignee: SYNACAST COMPUTER SYSTEM (SHANGHAI) CO., LTD., Shanghai (CN)

(21) Appl. No.: 12/894,093

(22) Filed: Sep. 29, 2010

Related U.S. Application Data
(60) Provisional application No. 61/247,344, filed on Sep. 30, 2009.

(51) Int. Cl. H04N 7/10; H04N 5/445

(52) U.S. Cl. 725/35; 725/42

(57) ABSTRACT

Methods of and devices for providing EPG in a content server and in a multimedia server for assistance are provided. The method of providing EPG comprises: obtaining the titles and playtime of a first number of multimedia contents; generating an electronic program guide including the titles and playtime of the first number of multimedia contents; and sending the electronic program guide to the user equipments. Furthermore, methods of and devices for posting and present advertisements are provided.

### TECHNICAL FIELD

The present invention relates to network multimedia applications. Specifically, the present invention relates to a method of and devices for providing electronic program guide and posting and presenting advertisements.

### BACKGROUND OF THE INVENTION

With the development of internet technology, internet multimedia has become a hot topic. In contrast to the cable TV, network-video has more abundant program contents. Network-video not only covers most of the cable TV channels, but also contains many other movies including TV drama programs. Network-video also furnishes 24-hour video looping, and user can click to watch any program he is interested according to the contents presented by the electronic program guide (EPG).

Generally, information of the multimedia contents presented by a conventional EPG includes the title, play time of the multimedia content, which is entered manually by a technician. To be specific, the technician edits the title, category information such as like live, VOD , or looping, play time, and the like of a multimedia content uploaded to a multimedia server in a preset format to form the conventional EPG The involvements of the technicians introduce low efficiency and unreliability due to human error.

Typical network advertising is mostly embedded on WEB page, e.g. the advertisement 10 in FIG. 1. Because of the strictly limited capability of WEB page itself, network advertising has been limited to text, pictures, flash and wmv. The network advertisement posting based on WEB page has too many difficulties to cope with the increasing requirements of the advertisers on the definition and expressiveness of advertisement.

The conventional methods of providing an EPG and posting/presenting advertisement are able to be improved.

### SUMMARY OF THE INVENTION

The embodiments of the present invention have furnished new solutions to provide an EPG, wherein human editor is avoided by using a computer server.

In first aspect, a method of providing an electronic program guide from a content server to user equipments comprises obtaining titles and playtime of a first number of multimedia contents, generating an electronic program guide including the titles and the playtime of the first number of multimedia contents; and sending the electronic program guide to the user equipments. In some embodiments, the method further comprises determining if there is an on-demand content corresponding to one or more live-like contents, wherein the one or more live-like contents is included in the multimedia contents; and obtaining an addressing information of the on-demand content if there is the on-demand content corresponding to the live-like contents, wherein the generated electronic program guide includes the obtained addressing information of the on-demand contents and the live-like contents include a live content or an looping content. In other embodiments, the generated electronic program guide further includes information related to content details of the first number of multimedia contents, information related to the content details themselves that are capable of being carried by the electric program guide directly, and information related to the content details comprising the addressing information that cannot be carried by the electric program guide directly. In some other embodiments, the content details include at least one of the following: information obtained by taking the content at one or more time points of every multimedia content; audio section information obtained by taking the content in at least one time slice of every multimedia content; video section information obtained by taking the content in at least one time slice of every multimedia content; and literal description of the content at one or more time point of the multimedia content or in at least one time slice of the multimedia content.

In second aspect, a method of using a multimedia server assisting a content server in providing an electric program guide to user equipments, comprises providing the content server with one or more titles and playtime of at least one multimedia content.

In some embodiments, the method further comprises providing the content server with content details of the at least one multimedia content, wherein the content details include at least one of the following: i. picture information obtained by taking the content at one or more time points of every multimedia content; ii. audio section information obtained by taking the content in at least one time slice of every multimedia content; iii. video section information obtained by taking the content in at least one time slice of every multimedia content; and iv. literal description of the content at one or more time point of the multimedia content or in at least one time slice of the multimedia content. In other embodiments, the method further comprises: providing the content server with classification information of at least one of the multimedia content, the classification information of each multimedia content indicating that the multimedia content belongs to on-demand content, looping content, or live content.

In third aspect, a device for using a content server providing an electric program guide to user equipments comprises a first unit configured to obtain titles and playtime of a first number of multimedia contents; a first generating unit configured to generate an electric program guide including the titles and playtime of the first number of multimedia contents; and a first transmitter configured to send the electric program guide to the user equipments.

In some embodiments, the device further comprises: a first determining unit configured to determine if there is an on-demand content corresponding to one or more live-like contents, wherein the live-content is included in the first number of multimedia contents and a second unit configured to obtain the addressing information of the on-demand content corresponding to the live-like content, wherein the electronic program guide generated by the first generating unit further includes obtained addressing information of the on-demand contents. In other embodiments, the electronic program guide generated by the first generating unit further includes information related to content details of the first number of multimedia contents, information related to content details themselves capable of being carried by the electric program guide directly, and information related to content details comprising addressing information which is not able to be carried by the electric program guide. In some other embodiments, the content details include at least one of the followings: a. picture information obtained by taking the content at one or more time points of every multimedia content; b. audio section information obtained by taking the content in at least one time slice of every multimedia content; c. video section information obtained by taking the content in at least one time slice of every multimedia content; and d. literal description of the content at one or more time point of the multimedia content or in at least one time slice of the multimedia content.

In forth aspect, a multimedia server for assisting a content server in providing an electric program guide to user equipments comprises a unit configured to provide a content server with the title and playtime of at least one multimedia content.

In some embodiments, the unit is configured to provide the content server with the content details of the at least one multimedia content, wherein the content details include at least one of the following: i. picture information obtained by taking the content at one or more time points of every multimedia content; ii. audio section information obtained by taking the content in at least one time slice of every multimedia content; iii. video section information obtained by taking the content in at least one time slice of every multimedia content; and iv. literal description of the content at one or more time point of the multimedia content or in at least one time slice of the multimedia content. In other embodiments, the unit is further configured to provide the content server with classification information of the at least one multimedia content, the classification information of each multimedia content indicating that the multimedia content belongs to on-demand content, looping content, or live content. In some other embodiments, the multimedia server further comprises a network server.

In fifth aspect, a method of using an advertising server posting advertisement, comprising determining a set of advertisements corresponding to each of multimedia contents according to respective characteristic of the multimedia contents; receiving a multimedia content request from a user equipment; analyzing the multimedia content request in order to determine the multimedia content requested by the multimedia content request; inquiring a set of advertisements corresponding to the requested multimedia content; instructing the user equipment to play at least one advertisement among the set of advertisements according to a preset rule. In some embodiments, different sets of advertisements are determined for different multimedia contents. In other embodiments, the method further comprises determining a subset of advertisements corresponding to a user group; determining the user group to which the user equipment belongs; searching, in the set of advertisements for the subset of advertisements corresponding to the user group which the user equipment belongs to; indicating the user equipment to play at least one of the advertisements in the subset according to a preset rule. In some other embodiments, the method further comprises determining a number of advertisements; receiving an advertisement pre-download request from a user equipment; and assisting the user equipment in pre-downloading the number of advertisements.

In sixth aspect, A method of presenting an advertisement, comprises generating a multimedia content request used to request for a multimedia content; sending the multimedia content request to an advertising server; and playing at least one advertisement corresponding to said multimedia content to based on instructions from the advertising server.

In some embodiments, the method further comprising determining whether a preset condition is satisfied; sending an advertisement pre-download request to the advertising server if the preset condition is satisfied; and pre-downloading a number of advertisements predetermined by the advertising server with the aid of the advertising server. In other embodiments, the pre-downloading further comprises monitoring an occupied bandwidth of the user equipment; and dynamically adjusting the bandwidth occupied by pre-downloading the number of advertisements according to the occupied bandwidth of the user equipment. In some other embodiments, the determining whether a preset condition is satisfied comprises determining whether any of the following conditions has been satisfied: the user equipment connects to the network; and the user equipment starts to run a particular application program. In some embodiments, the playing at least one advertisement further comprises determining whether the advertisement has been completely downloaded when an advertisement is needed to be played according to the preset rule; and skipping the play of the advertisement if the advertisement has not been completely downloaded.

In seventh aspect, a device for-posting advertisement comprises a first unit configured to determine a set of advertisements corresponding to each of the at least one multimedia content according to respective characteristic of at least one multimedia content; a receiver configured to receive a multimedia content request from a user equipment; a second unit configured to analyze said multimedia content request in order to determine the multimedia content requested by the multimedia content request; inquiry unit configured to inquire about a set of advertisements corresponding to the requested multimedia content; a third unit configured to instruct the user equipment to play at least one advertisement among the set of advertisements according to a preset rule.

In some embodiments, sets of advertisements are different for different multimedia contents. In other embodiments, the first unit is further configured to: determine a subset of advertisements corresponding to the user group; and wherein the second unit is further configured to determine the user group to which the user equipment belongs; wherein the inquiry unit is further configured to search, in the set of advertisements for the subset of advertisements corresponding to the user group which a user equipment belongs to; wherein the third unit is further configured to indicate the user equipment to play at least one of the advertisements in the subset according to a preset rule.

In some embodiments, the device further comprises a fourth unit configured to determine a number of advertisements, wherein the receiver is further configured to receive an advertisement pre-download request from a user equipment; and an fifth unit configured to assist the user equipment in downloading the number of advertisements. In other embodiments, a device for presenting an advertisement, comprise a generating unit configured to generate a multimedia content request used to request for a multimedia content; a transmitter configured to send the multimedia content request to an advertising server; and a player configured to play at least one advertisement corresponding to said multimedia content based on instructions from said advertising server. In some other embodiments, the device further comprises a first determining unit configured to determine whether a preset condition is satisfied; wherein the transmitter is further configured to-send an advertisement pre-download request to the advertising server if the preset condition is satisfied; and downloader configured to pre-downloading a number of advertisements predetermined by the advertising server with the aid of the advertising server. In some embodiments, the device further comprises a monitor configured to monitor an occupied bandwidth of the user equipment; and an adjustment unit configured to dynamically adjust the bandwidth occupied by pre-downloading the third number of advertisements according to the occupied bandwidth of the user equipment. In some other embodiments, the first determining unit is further configured to determine that the preset condition is satisfied when any of the following conditions has been satisfied: the user equipment connects to the network; and the user equipment starts to run a particular application program. In some embodiments, the player further comprises: a second determining unit configured to determine whether the advertisement has been completely downloaded when an advertisement is needed to be played according to the preset rule; and wherein the player is further configured to skip the play of the advertisement if the advertisement has not been completely downloaded. In other embodiments, the device further comprises an advertising server.

In some embodiments of the present invention, since the EPG is able to be is generated and provided by a network server, there is no need to involve technicians so much, which not only frees the technicians, but also avoids undesirable consequences as a result of human error. According to some embodiments, an EPG further includes the content details of related multimedia content. The content details can be screen shot at one or more time points of the multimedia content, or, audio/video clips or literal description of at least one time slice of the multimedia content. A user can, according to the content details in relation with every multimedia content presented by the EPG, select a multimedia content of his/her interest to enjoy. Advantageously, especially for live-like content including but not limited to live content and looping content, if a user has missed a part of it, he/she can know about some details of the missed part relying on the content details of the multimedia content presented by the EPG, which offers better user experience.

Being different from conventional network advertisement posting solution based on WEB, an advertising server provided by the present invention is capable of, according to a request raised by the user for a multimedia content, posting on a UE at least one advertisement among the set of advertisements corresponding to the characteristic of the requested multimedia content by control. Therefore, it is possible to post advertisement in a well-directed way. Besides, according to some embodiments, advertisements posting are in connection with user groups classified by some criteria including classifying users according to region. In addition, by downloading advertisements in advance, the quality of downloading the multimedia contents is able to be less affected, so that users' experience is improved.

### BRIEF DESCRIPTION OF THE DRAWINGS

Other features, objects and advantages of the present invention will be more apparent by reference to the following detailed description of non-limited exemplary embodiments, when taken in conjunction with the accompanying drawings, wherein same or similar reference signs refer to same or similar step features/means (module).

FIG. 1 illustrates a WEB page containing advertisements of a prior art.

FIG. 2 illustrates a network structure for generating and providing an EPG according to some embodiments.

FIG. 3a illustrates a flowchart of a systematic method of providing an EPG according to some embodiments.

FIG. 3b illustrates a flowchart of a systematic method of providing an EPG according to some embodiments.

FIG. 4 is a block diagram of a first device in a content server for providing an EPG to UEs according to some embodiments.

FIG. 5 is a block diagram of a device in a multimedia server for assisting a content server in providing an EPG to UEs according to some embodiments.

FIG. 6 illustrates a network structure according to some embodiments.

FIG. 7a illustrates a flowchart of a method of posting and presenting advertisements according to some embodiments.

FIG. 7b illustrates a flowchart of a method of posting and presenting advertisements according to some embodiments.

FIG. 8 is a block diagram of a device in an advertising server for posting advertisements according to some embodiments.

FIG. 9 is a block diagram of a device in a UE for presenting advertisements according to some embodiments.

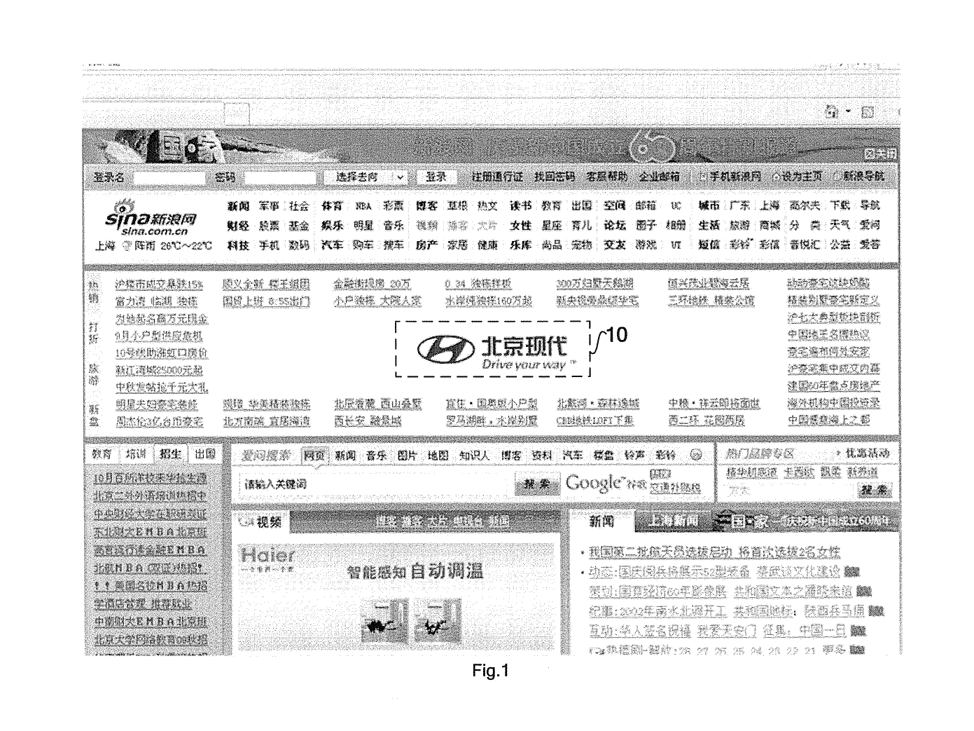

### DETAILED DESCRIPTION OF THE EMBODIMENTS

A method of providing an EPG according to some embodiments of the present invention is introduced hereinafter with reference to the accompanying drawings.

It should be appreciated that, according to any solution in relation with the present invention, a network server for generating an EPG and providing the same to UEs and a multimedia server for providing multimedia content to UEs can be two separate servers or integrated into one single server.

In the following, reference are made to the technical solutions provided by the invention by focusing on the scenario wherein the network server and the multimedia server are separated, this is able to decrease the load of the multimedia server. A person of ordinary skill in the art is able to apply the solution in the disclosure to the scenario wherein the two servers are integrated into one single server, which is within the scope of the present disclosure. Here, a network server for providing an EPG is also able to be referred to as a content server when a multimedia server is configured to provide an EPG to UEs, so that it is a content server at the same time.

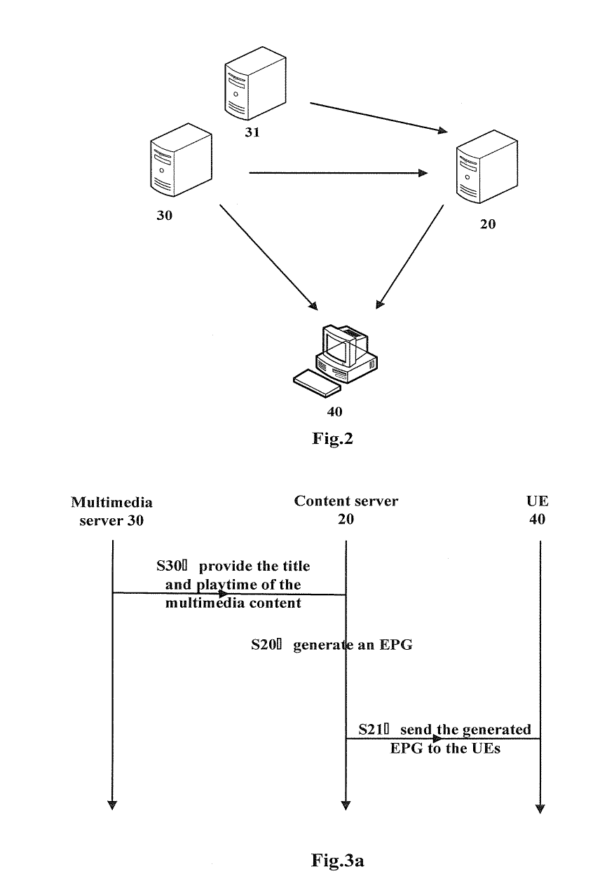

FIG. 2 illustrates an interne network structure for generating and providing an EPG according to some embodiments. The network includes a content server 20, multimedia servers 30 and 31 and a plurality of UEs (user equipments). Here only UE 40 is shown for conciseness. Those skilled in the art would understand that UE 40 includes: computers, cell phones, and personal digital assistants. It is appreciated that quantitative relation between content server and multimedia server is not limited to what is shown in FIG. 2. In some embodiments, a content server is able to serve one or more than one multimedia servers.

Multimedia servers 30 and 31 are multimedia content (e.g., video program) providers. The multimedia servers 30 and 31 are able to store one or more multimedia contents, such as live contents, on-demand contents, or looping contents. Here , “live” is able to mean producing and broadcasting multimedia contents with the happening and development of an event;

“looping” is able to mean playing at least one multimedia content end-to-end; “on-demand” is able to mean storing multimedia contents in a multimedia server and playing the contents according to the instructions from a user. In the context, live and looping are able to be referred to as live-like.

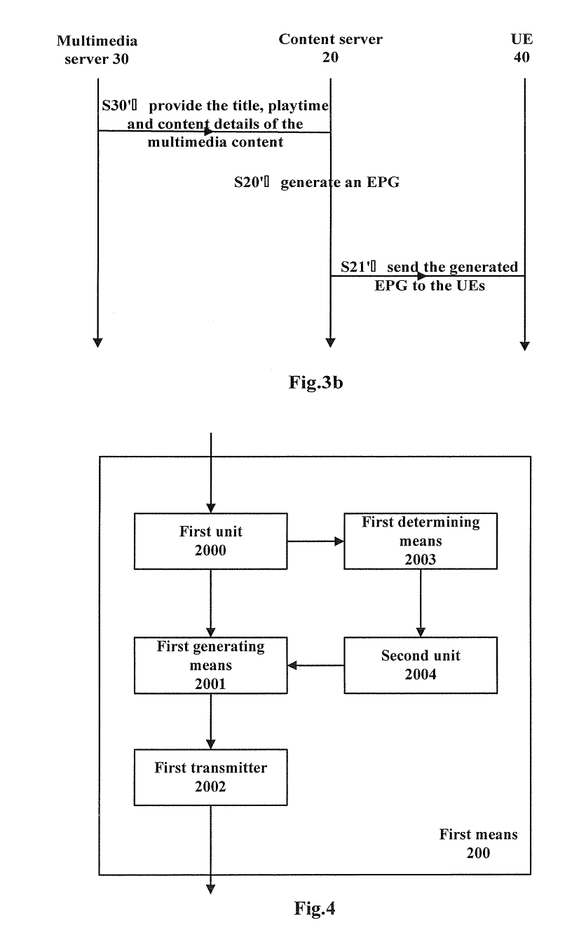

FIG. 3a is a flowchart illustrating a method of providing an EPG according to some embodiments. A content server is capable of firstly, obtaining titles and playtime of a first number of multimedia contents; subsequently, generating an EPG including the titles and playtime of the first number of multimedia content; and finally, sending the generated EPG to UEs.

Referring to FIG. 3a, the flow is described in further details. The multimedia server 30 is used as an example. Those skilled in the art understand that, if multimedia server 31 also takes part in the process, it is capable of performing the same or similar procedures as multimedia server 30 does. The method starts from Step S30, multimedia server 30 provides content server 20 with title and playtime of at least one multimedia content. The multimedia server 30 is responsible to provide the content server 20 above mentioned information. This example is particularly suitable when the multimedia content belongs to a live-like service, wherein the playtime of a multimedia content is at its beginning and/or ending in a live or looping service. Similarly, this example is also applicable when the multimedia content belongs to an on-demand service, wherein the playtime of the multimedia content is concurrently at the time of the on-demand service. Of course, it is possible that a part of the multimedia content provided by the multimedia server belongs to live-like service, while the rest part of the multimedia content belongs to on-demand service, which also falls into the scope of the present disclosure.

In Step S20, the content server 20 generates an EPG including the titles and playtime of all multimedia contents obtained in Step S30. An illustrative example of the EPG is shown in Chart 1:

CHART 1
An EPG

| Title | Playtime |
|---|---|
| Multimedia content M2 | 00:00-06:00 |
| Multimedia content M2 | 06:00-12:00 |
| Multimedia content M3 | 12:00-18:00 |
| Multimedia content M4 | 18:00-00:00 |

Multimedia contents M2-M4 all belong to live-like services. In step S21, the EPG is provided to UE 40, then the user is aware of the past, on-going and coming programs. Specifically, the content server 20 is able to send the generated multimedia content description to the UE 40 by using protocols like HTTP, UDP, TCP or P2P. It should be noted that the content description server 20 is able to send the generated multimedia content description to UE 40 by other protocols.

The example illustrated in FIG. 3a is simplified, wherein the EPG automatic generated. In the next example, the EPG shown in Chart 1 is able to be optimized.

FIG. 3b is a flowchart illustrating a method of providing an EPG according to some embodiments. In Step S30′, the multimedia server 30 provides the content server 20 with the content details of multimedia contents M2-M4. The content details of each multimedia content is able to be in relation with the content at one or more time points of the multimedia content or the content during at least one time slice of the multimedia content.

The content details of a multimedia content is able to include: picture information got by grabbing the image (video data frame) at one or more time points of the video content if the multimedia is a video content; audio section got by grabbing the audio in at least one time slice of the multimedia content if the multimedia content is an audio content or video content; video section got by grabbing the video data in at least one time slice of the video content if the multimedia content is a video content, literal description of the content at one or more time point of the multimedia content or in at least one time slice of the multimedia content. It should be appreciated that the content details of a multimedia content is able to cover other kinds of information.

As one of the choices, the multimedia content is able to identify the conversation between the characteristics by using speech recognition technology according to the audio section of the multimedia content during a time slice, so as to generate literal description corresponding to the time slice, that is to say, this literal description is content abstract of that time slice. Alternatively, the content abstract of that time slice is able to be obtained by loading the subtitle.

Hence, in Step S20′, the content server 20 generates an EPG including information related to the content details of every multimedia content. Here, said information related to the content details should be understood as a generalized concept. Without loss of generality, information related to content details like screenshots, audio or video sections are able to be the addressing information thereof, and information related to content details like literal description are able to be the content details themselves. This difference is able to stem from that existing EPGs are usually formed as XML files, therefore, when the content details are pictures, audio/video sections or other contents which cannot be carried by the EPG directly, addressing information thereof will be preferably carried by the marking language codes of the EPG After that, when the EPG is presented to the user, he/she is able to click the addressing information to enjoy the pictures or audio/video. In addition, when the content details are literal information which is able to be carried by marking language codes, the content details are able to be written into the EPG in a proper manner, so that the content details is able to be parsed and presented normally by the local browser at UE 40. With the development of network technologies, the format of an EPG is able to change, the present invention should be understood as being not limited to the embodiments as above but covering diversified evolution of the embodiments.

In step S21′, the content server 20 sends the generated EPG to the UE 40.

After receiving the EPG shown in Chart 2, UE 40 presents the EPG to the user. In specific, a screenshot of a video content can be presented in the format of JPEG; an audio section is able to be presented in MPEG3, WAV format; a video section may be presented in MPEG 4, AVI, RMVB format.

An EPG presented by UE 40 in some embodiments are able to take the form as shown in Chart 2:

CHART 2
A preferred EPG

| Title | Playtime | Summary | Content details | |
|---|---|---|---|---|
| Multimedia | 00:00-06:00 | ***** | Time point t1 | Time point t2 |
| content M2 | | | and screenshot | and screenshot |
| Multimedia | 06:00-12:00 | ***** | Time point t3 | Time point t4 |
| content M2 | | | and screenshot | and screenshot |
| Multimedia | 12:00-18:00 | ***** | Time point t5 | Time point t6 |
| content M3 | | | and screenshot | and screenshot |
| Multimedia | 18:00-00:00 | ***** | Time point t7 | Time point t8 |
| content M4 | | | and screenshot | and screenshot |

The column named as Summary (not shown in Chart 1) is usually man-made description of the multimedia content and is most likely inputted with the aid of technicians. Summary, which is frequently used in an existing EPG, is optional in the present invention.

In the context, the content details of each multimedia content which are used by the content server 20 to generate an EPG have been provided directly by the multimedia server after parsing the multimedia contents. This example is not to limit the present invention, according to embodiments of the invention. Methods of the content server 20 to obtain the content details of the multimedia contents further include: [1] (for on-demand or looping multimedia contents) the content server 20 gets from the multimedia servers 30, 31 a part of or all of the data of the multimedia contents in advance, and is grabs pictures or audio/video sections to form the content details; [2] (for live multimedia content, since this kind of multimedia cannot be obtained in advance) the content server 20 receives the multimedia contents during the live broadcast process as the UE 40 does, and then forms the content description based hereupon.

With respect to the method [1], if multimedia server 30 keeps sending data of a multimedia content to content server 20, a part of the total bandwidth of the multimedia server 30 are able to be always occupied by the content server 20, this occupied bandwidth becomes more notable when the multimedia server 30 is using client-server techniques for data transmission. The applicant of the present invention realizes that the content details of a multimedia content are typically distributed in multiple time points/sections within the playtime, and hence the multimedia server 30 sends some data of the multimedia content to the content server 20 periodically, in order for the content server 20 to get the content details of the multimedia content.

In addition, still with respect to method [1], the content server 20 is able to passively receive multimedia content from the multimedia server 30 or requests on its own initiative and then receives the requested multimedia content. Since the download of data pieces is generally based on the principle of request, that is to say, a download source will not send a data piece to a download requester until a request for downloading the data piece from the download requester has been received. Therefore, this solution in which the content server 20 requests for receiving the multimedia content is particularly applicable when the transmission of multimedia content between the multimedia server 30 and the content server 20 is based on P2P protocol.

Whether the content details are provided by the multimedia servers 30 and 31 directly or extracted by the content server 20 itself from the original data, the content server 20 is able to store the obtained content details in order to generate a new EPG

The content server 20 provides the UE with the addressing information of on-demand contents corresponding to the live-like contents listed on the EPG This additional feature can be used in the solution illustrated in FIG. 3a or used in the solution in FIG. 3b as an improvement.

Specifically, each multimedia server is able to inform content server 20 of the category information of the multimedia content provided by itself. Thus, before generating an EPG, the content server 20 conducts the following process for each live-like content, wherein, generally, it is assumed that multimedia contents provided by multimedia servers 30, 31 which amount to a first number include a second number of live-like contents:

Firstly, it is determined if there is an on-demand content corresponding to the live-like content. The determining process is able to rely on the title and category information of the multimedia content provided by the multimedia server, e.g. when the title of a looping content provided by a multimedia server is the same as the title of an on-demand content provided by another multimedia server, the on-demand content is able to be considered as being corresponding to the looping content. To avoid missing, preferably, even though some certain multimedia content especially an on-demand content will not appear in the EPG, the multimedia server still informs the content server 20 of information in relation to the determination, such as the title and category information of the multimedia content.

After that, if there is on-demand content corresponding to the live-like content, the addressing information of the on-demand content will be obtained. By choosing the addressing information presented on the EPG, the user is able to then enjoy the on-demand content.

This method combining on-demand and live-like broadcast can meet the requirements of the user to greatest extent. Especially for a looping content, if the user has missed the already-run part of it in which he/she is really interested, he/she is able to click addressing information like a link of the on-demand content corresponding to the looping content to make the UE 40 visit the multimedia server for providing the on-demand content by establishing a connection to receive the data stream.

On the basis of the detailed description of the method of providing an EPG, brief reference will be made to the first and second devices which correspond to the method, wherein the description of the method is used as reference here.

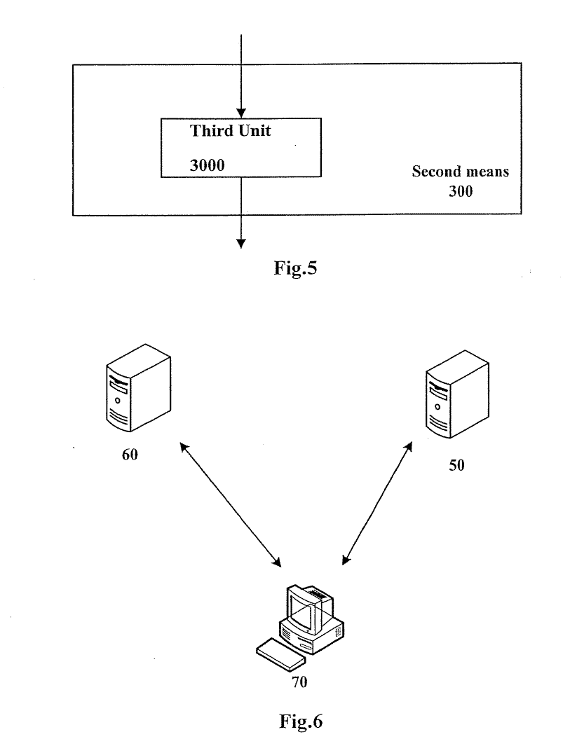

The first device for, in a content server, providing an EPG to UEs is illustrated in FIG. 4. The first device 200 comprises: a first unit 2000 configured to obtain the titles and playtime of a first number of multimedia contents, which corresponds to the aforesaid step S30 and step S30′; a first generating unit 2001 configured to generate an EPG including the titles and playtime of the first number of multimedia contents, which corresponds to the step S20 and step S20′; a first transmitter 2002 configured to send the EPG to the UEs, which corresponds to the steps S21 and S21′.

In some embodiments, the first number of multimedia contents include a second number of live-like contents, the first device 200 further includes: a first determining unit 2003 configured to, for each of the live-like contents, determine if there is any on-demand content which corresponds to the live-like content; a second unit 2004 configured to, for each live-like content is to which a on-demand content corresponds, obtain the addressing information of the on-demand content corresponding to the live-like content; wherein the EPG generated by the first generating unit 2001 further includes the obtained addressing information of the on-demand content(s).

Furthermore, the EPG generated by the first generating unit 2001 includes information related to the content details of the first number of multimedia contents, wherein information related to content details which can be carried by the EPG directly are the content details themselves, and information related to content details which cannot be carried by the EPG directly are the addressing information thereof.

Furthermore, the content details include at least one of the followings: picture information got by grabbing the content at one or more time points of every multimedia content; audio section information got by grabbing the content in at least one time slice of every multimedia content; video section information got by grabbing the content in at least one time slice of every multimedia content; literal description of the content at one or more time point of the multimedia content or in at least one time slice of the multimedia content.

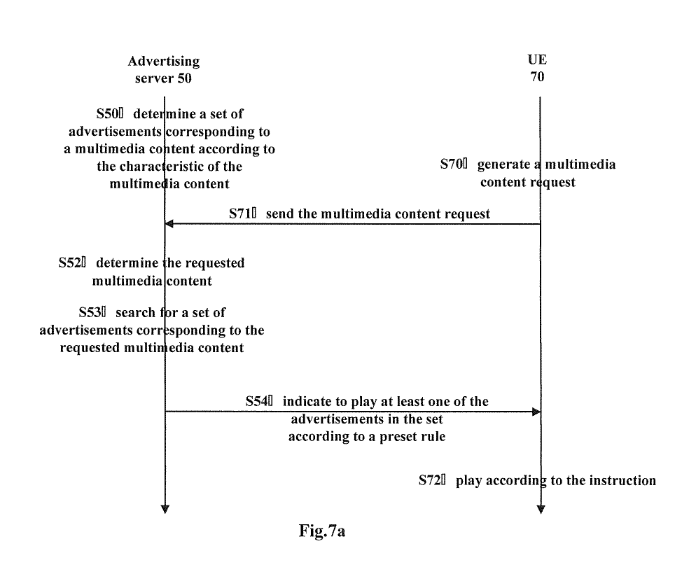

A second device in a multimedia server for assisting a content server in providing an EPG to UEs according to some embodiments of the invention is illustrated in FIG. 5. The second device 300 comprises: a third unit 3000 configured to provide the content server with the title and playtime of at least one multimedia content, which corresponds to step S30.

Furthermore, the third unit 3000 is configured to provide content details of the at least one multimedia content to the content server, which corresponds to Step S30′. The content details include at least one of the followings: picture information got by grabbing the content at one or more time points of every multimedia content; audio section information got by grabbing the content in at least one time slice of every multimedia content; is video section information got by grabbing the content in at least one time slice of every multimedia content; literal description of the content at one or more time point of the multimedia content or in at least one time slice of the multimedia content.

Furthermore, the third unit 3000 is configured to inform the content server of the category information of the at least one multimedia content, the category information is used to show that its corresponding multimedia content belongs to one of the followings: on-demand content, looping content, or live content.

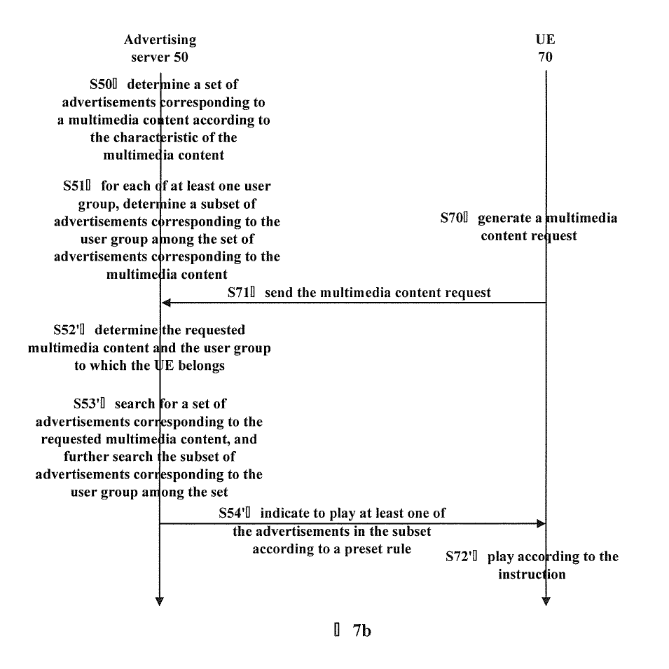

Now reference will be made to the method of posting an advertisement and presenting an advertisement according to some embodiments, in conjunction with the network structure illustrated in FIG. 6. Here, an advertising server 50, a multimedia server 60, and a UE 70 are illustrated, it should be understood that any number of the components in the drawing are applicable.

In some embodiments, an application program has been typically installed on the UE 70, which is for the user to enjoy online multimedia content. Hereinafter, video content will be taken as an example. In specific, UE 70 runs this application program to connect to the multimedia server 60, so as to obtain multimedia data stream and play the same locally.

Being configured properly, the application program makes it possible that the UE 70 visits the advertising server 50 at the right time, in order to obtain and play at least one of the follows: advertisement for buffering, interlude advertisement, superscript advertisement and ending advertisement. The advertisement for buffering is typically played after the user clicked a multimedia content and before playing the multimedia content. The interlude advertisement is played when a multimedia content is played halfway. The superscript advertisement is able to be shown at the edge or corner of the video window of the multimedia content, and it is able to be there throughout is the playtime of the multimedia content since very limited area will be occupied thereby. The ending advertisement is able to be presented when the play of a multimedia content has finished.

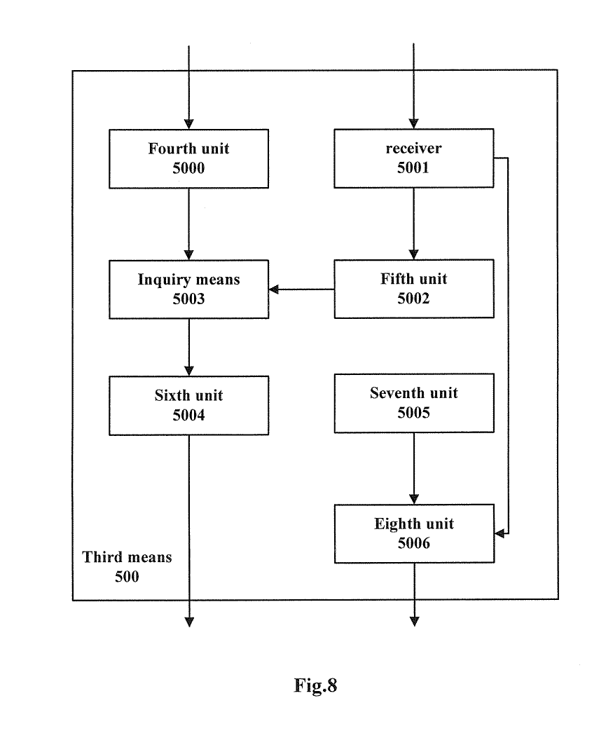

FIG. 7a illustrates a flowchart of a method of posting and presenting advertisements according to some embodiments. FIG. 7a is able to be read together with FIG. 6. It should be appreciated that the steps in the flowcharts disclosed herein are not limited to one-to-one basis and any numbers of the components are applicable. Any steps included in any of the flowcharts are able to be combined to be used with any steps in any of the flowcharts disclosed herein. The method of posting advertisements according to some embodiments is well-directed posting. To be specific, for a certain multimedia content, in step S50, the advertising server 50 determines a set of advertisements from an advertisement pool according to the characteristic of the multimedia content. This set of advertisements is referred to as the set of advertisements corresponding to the multimedia content. What's important, when referring to the methods of and devices for posting or presenting advertisements provided by the embodiments of the present invention, a multimedia content is able to contain an individual video or audio file, like Episode 1 of a TV series. A multimedia content according to embodiments of the present invention includes but is not limited to the followings: (1) an individual video file or audio file, e.g. a file containing an Episode of a TV series, or, a file containing a part of a movie or the whole movie and (2) a channel, in which the live show, looping show or on-demand show of a kind of programs is supported.

A set of advertisements is able to uniformly determined for every part of a series, e.g. every Episode of a TV series, as the set of advertisements corresponding to each of them. For instance, for a TV series for children, at least one advertisement about stationery, games, study is able to be taken as the set of advertisements. There are diverse manners of determining the set of advertisements, e.g. the set can be defined by an editor or technician artificially. In some cases, the name of either an advertisement or a multimedia content is able to represent the content of the advertisement or multimedia content and hence can be considered as the characteristic thereof. Some advertisements have been granted a name when it was uploaded to the advertising server and some multimedia contents have name assigned or associated with. The names mentioned above are able to be used as criteria for determining the set of the advertisements. In some cases, the advertising server 50 uses the name of the multimedia content as a keyword and searches in the names of the advertisements for the match of the keyword, in order for determining a set of advertisements each advertisement in which has a name matching the name of the multimedia content.

In some embodiments, the manner of searching matches is able to rely on character-based exact matching or fuzzy matching using algorithms, wherein the name of a multimedia content is able to be provided by the multimedia server 60 to the advertising server 50.

A multimedia content is able to be granted with a characteristic once it is uploaded to the multimedia server, and the characteristic is then forwarded to the advertising server in order for determining the set of advertisements.

In some embodiments, when determining the set of advertisements corresponding to a multimedia content, there is able to be more than one predefined sets of advertisements. These sets of advertisements are able to have commonality. For example, they are all about sporting goods or fashion. In addition, define adaptability condition for each of the sets of advertisements, when a multimedia content satisfies the adaptability condition of a set of advertisements, this set of advertisements will be determined to be corresponding to the multimedia content.

In some embodiments, if a channel named as “FOOTBALL” is taken as a is multimedia content, a set of advertisements corresponding to the channel name is able to preferably be a set of advertisements for sporting goods, and more preferably a set of advertisements for soccer equipments.

In Step S50, to avoid a situation when it is difficult to determine the set of advertisements corresponding to a multimedia content, a predefined set of hot advertisements are able to be determined corresponding to the multimedia content. Without loss of generality, the set of hot advertisements are able to be defined for an advertiser through paying some fees.

In some embodiments, sets of advertisements determined for different multimedia contents are able to be the same or different. In addition, sets of advertisements determined for channels with very different contents are able to be not the same.

As long as the sets of advertisements corresponding to every multimedia content have been determined, the advertising server 50 is able to take its turn to post and present advertisements. In some embodiments, posting and presenting advertisements are able to be triggered when a user clicks to watch a multimedia content. Hence, when the user runs the aforesaid application program like pplive.exe and clicks a multimedia content like a looping channel named as “FOOTBALL”, the method enters into the step S70, and the application program generates a multimedia content request including the identifier of the looping channel named “FOOTBALL”.

In step S71, the generated multimedia content request is able to be sent out. In some embodiments, the multimedia content request is able to be sent to the multimedia server providing “FOOTBALL” and then forwarded by the multimedia server to the advertising server 50. Alternatively, pplive.exe, after being properly configured, sends the generated multimedia content request directly to the multimedia server and the advertising server 50.

The aforesaid embodiments of how the multimedia content request gets to the advertising server 50 are some of the examples and should not be is considered to limit the scope of the present invention.

After receiving the aforesaid multimedia content request, the advertising server 50 carries the Step S52 out, wherein it determines the requested multimedia content according to the multimedia content request, e.g. by extracting the identifier of the multimedia content included in the request.

In Step S53, the advertising server 50 uses the identifier of the requested multimedia content as the entry to search for the set of advertisements preset for the multimedia content.

In Step S54, the advertising server 50 instructs the UE 70 to play, according to a preset rule, at least one advertisement in the set of advertisements. The UE 70 then plays at least one advertisement based on the aforesaid instruction in Step S72.

Steps S54 and S72 are able to be performed as below:

The advertising server 50 (refer to the advertisement arrangement defined by the multimedia content and its corresponding set of advertisements) instructs the UE 70 to download at least one advertisement in the set. The advertising server 50 is also able to inform the UE 70 of the category information of the advertisement (i.e., advertisement for buffering, interlude advertisement, superscript advertisement or ending advertisement) in order for the UE 70 to play the advertisement properly. Besides, for the advertisements which the advertising server has instructed the UE 70 to download, if some of them are played in a looping way as the same kind of advertisements (e.g., several advertisements will be played in a looping way as advertisements for buffering before playing the video) the advertising server 50 further informs the UE 70 of the playback order among these advertisements. Further, if there are more than one advertisement of the same type in the set of advertisements corresponding to a multimedia content, the advertising server 50 is able to choose at least one of them, and instruct the UE 70 to download and play the same.

Various advertisements can be presented together with the video image by utilizing window overlay. An interlude advertisement and an advertisement for buffering or an ending advertisement are able to take the whole screen or only a part of the screen, then the video image of the multimedia content are able to be compressed and take the rest part of the screen.

In Step S72, when an advertisement is not completely downloaded but needs to be played, the UE 70 is able to wait and play this advertisement when the download is complete. Alternatively, the play of this advertisement is able to be skipped, and an advertisement or multimedia content expected to be played after this advertisement is able to be played instead.

In the step S72, the UE 70 monitors the data flow rate at its network card and dynamically adjusts the bandwidth for downloading advertisements in order to prevent affect the normal use of the network.

In FIG. 7b, taking a multimedia content like the channel named as “FOOTBALL” for which the corresponding set of advertisements have been determined as an example, the method further comprises a Step S51: for each of at least one user group, determining a subset of advertisements corresponding to each user group among the set of advertisements corresponding to the multimedia content according to the characteristic of the at least one user group.

If the set of advertisements determined for the channel “FOOTBALL” is for football gears, there are able to be advertisements for football shirts, football boots of companies like Nike, Adidas and Umbro. The advertisements in this set are able to be divided into subsets of advertisements in Step S51.

In some embodiments, advertisements are able to be posted with high pertinence in connection with user groups. One of exemplary embodiment is that since the UE 70, the content server 50, and the multimedia server 60 are all working in the Internet, the multimedia content request is able to contain the IP address of the UE 70. By parsing a certain section of the IP address, even every numeric character of the IP address, the content server 50 can be aware of the location of the UE 70. Nowadays, it is already possible for the content server 50 to determine the city in which the UE 70 is located.

As thus, different user groups (e.g., user groups in different cities) are able to have different demands for commodities and advertisements. For example, for user groups in a developed country or city, subsets of advertisements corresponding to middle-end and/or high-end commodities in the set of advertisements are able to be determined. On the contrary, for user groups in a less developed area, subsets of advertisements corresponding to low-end and/or middle-end commodities in the set can be determined. Downloading advertisements does take some bandwidth, so if they are posted with higher pertinence, it will be propitious to save the network bandwidth and guarantee better user experience without violating the advertisers.

Henceforth, with the continuous development of the network technology, the definition and classification of user groups is able to become more detailed and accurate. The present invention, however, should be understood as covering this kind of possible variations. In some embodiments, the multimedia content request includes the unique identifier of the UE 70 indicating the model information of the UE 70. The model information of the UE furnishes additional information to the advertising server 50 such like the user's purchasing power. Thus, besides the region, economic power or predilection are also able to be used as criterions for classifying user groups, these and other criterions can be used jointly to further classify the user groups.

In Step S52′, the advertising server 50 determines not only the requested multimedia content, but also the user group to which the UE 70 belongs. In this embodiment, the UE 70 is the property of a British boy living in Manchester, hence UE 70 is determined to correspond to a user group of the city.

As a matter of fact, in the step S51, a more detailed subset of advertisements has already been determined for the user group of Manchester, which is one of the subsets determined for “FOOTBALL” channel, advertisements in this subset include or only include the ones for soccer gears from Nike, because Nike is the sponsor of Manchester United (MU), so the fans of MU may prefer goods from Nike when they need to buy some soccer gears.

Hence, in step S53′, the advertising server 50 is able to find this subset of advertisements. In step S54′, it indicates that the UE 70 to play at least one of the advertisements in the subset. UE 70 follows the instruction in step S72′. See the reference made to steps S54 and S72 for the details of steps S54′ and S72′.

As mentioned above, downloading advertisements will more or less impact the user experience if the user is enjoying the chosen multimedia content, as such, according to a most preferred embodiment of the invention, a solution which is called pre-download is provided. Wherein, the processes of defining sets or subsets of advertisements and playing the advertisements can be carried out based on the pre-download of advertisements.

The advertising server 50 determines a third number of advertisements in advance (e.g. it determines the advertisements to be played today as the third number of advertisements.)

Accordingly, UE 70 determines whether a preset condition is satisfied, and sends an advertisement pre-download request to the advertising server as long as the preset condition is satisfied. The advertisement pre-download request is used for requesting the advertising server 50 for downloading the third number of advertisements.

After that, the advertising server 50 is able to assist the UE 70 in pre-downloading the advertisements. The advertising server 50 is able to provide an advertisement list to the UE 70, which includes some network addresses. By visiting these addresses, the UE 70 is able to get the corresponding advertisements.

Pre-download is able to mean the process of said request and download happens before the user clicks to enjoy some multimedia content. Therefore, the preset condition is able to include any of the followings: the UE 70 connects to the network and UE 70 starts to run particular application program like pplive.exe.

Since the user is able to use the network during the process of pre-download, preferably, the UE 70 monitors the occupied bandwidth of itself when pre-downloading the advertisements such like the data rate at the network card, so as to adjust the bandwidth occupied by the pre-download dynamically.

Nowadays, the size of an advertisement is usually smaller than 1 MB, the advertisements need to be pre-downloaded is able to amounts to 30. Through a test, if the pre-download starts as soon as the application program is started, the impact to the download of the multimedia content chosen by the user is likely not notable, which guarantees the user experience.

When downloading advertisements according to some embodiments, http and p2p methods are able to be used jointly so as to relieve the stress of the advertising server 50 while improving the success ratio of download.

On the basis of the detailed description of the method of posting and presenting advertisements, brief reference will be made to the third and fourth means which correspond to the method, wherein the description of the method is used as reference here.

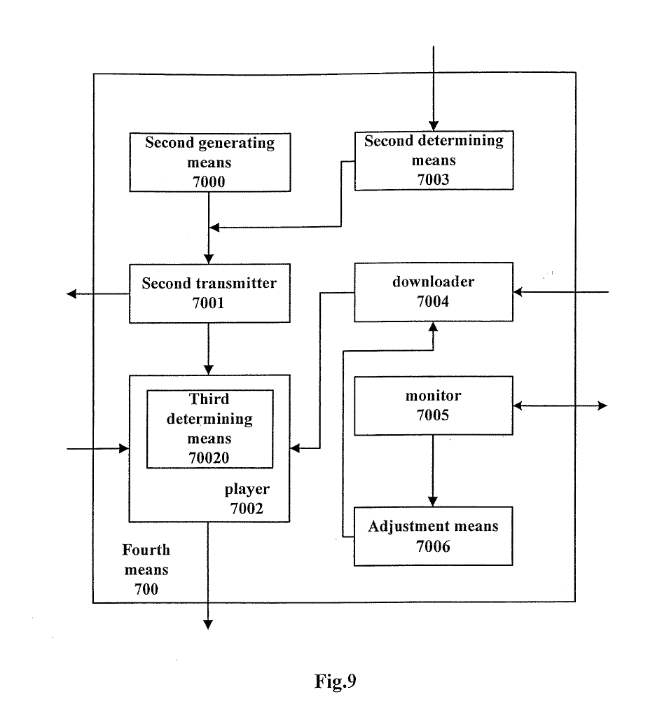

Referring to FIG. 8 is a block diagram illustrating a third means in an advertising server for posting advertisements to UEs according to some embodiments, which is typically arranged in the advertising server 50 in FIG. 6. The third device 500 includes: a fourth unit 5000 configured to, according to respective characteristic of at least one multimedia content, determine a set of advertisements corresponding to each of the at least one multimedia content, which is corresponding to the step S50; a receiver 5001 configured to receive a multimedia content request from a UE, which corresponds to the step S71; a fifth unit 5002 configured to analyze said multimedia content request, in order to determine the multimedia content requested by the multimedia content request, which corresponds to the step S52; an inquiry means 5003 configured to inquire about a set of advertisements corresponding to the requested multimedia content; a sixth unit 5004 configured to instruct the UE to play at least one advertisement among the set of advertisements according to a preset rule.

Further, the sets of advertisements determined by the fourth unit 5000 for different multimedia contents are different. Further, the fourth unit 5000 is configured to (with respect to every multimedia content, for each of at least one user group, according to the characteristic of the at least one user group) determine a subset of advertisements corresponding to the user group among the set of advertisements corresponding to the multimedia content, which corresponds to the step S51;

The fifth unit 5002 is further configured to determine the user group to which the UE belongs, which corresponds to the step S52′;

The inquiry unit 5003 is further configured to search (in the set of advertisements corresponding to the requested multimedia content) for the subset of advertisements corresponding to the user group which the UE belongs to, this corresponds to step S53′;

The sixth unit 5004 is further configured to indicate the UE to play at least one of the advertisements in the subset according to a preset rule, which corresponds to step S54′.

In some embodiments, the third device 500 further includes: a seventh unit 5005 configured to determine a third number of advertisements. The receiver 5001 is further configured to receive an advertisement pre-download request from a UE. The third device 500 further includes an eighth unit 5006 configured to assist the UE in downloading the third number of advertisements.

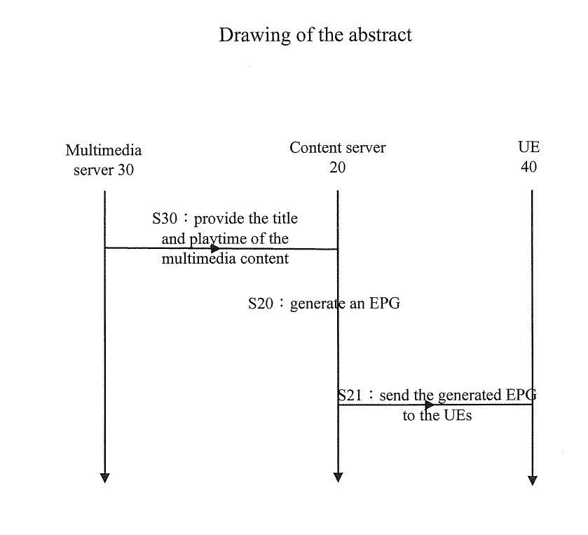

In some embodiments, there is provided a fourth devices in a UE for presenting advertisements as illustrated in FIG. 9. The fourth device 700 comprises: a second generating means 7000 configured to generate a multimedia content request for requesting for a multimedia content, which corresponds to step S70; a second transmitter 7001 configured to send the multimedia content request to an advertising server, which corresponds to the step S71; a player 7002 configured to, based on the instruction from the advertising server, play at least one advertisement corresponding to the multimedia content, which is in relation with step S72.

In some embodiments, the fourth device 700 further comprises: a second determining unit 7003 configured to determine whether a preset condition is satisfied; the second transmitter 7001 is further configured to, if the preset condition is satisfied, send an advertisement pre-download request to the advertising server; a downloader 7004 configured to, with the aid of the advertising server, pre-downloading a third number of advertisements predetermined by the advertising server.

The fourth unit 700 further comprises: a monitor 7005 configured to monitor the occupied bandwidth of the UE; an adjustment means 7006 configured to, according to the occupied bandwidth of the UE, adjust the bandwidth occupied by pre-downloading the third number of advertisements dynamically.

Furthermore, the second determining units 7003 is configured to, determine that the preset condition is satisfied when any of he following is conditions has been satisfied: the UE connects to the network or the UE starts to run a particular application program.

Furthermore, the player 7002 comprises: a third determining unit 70020 configured to, when an advertisement is needed to be played according to the preset rule, determine whether the advertisement has been completely downloaded; the player 7002 is further configured to, if the advertisement has not been completely downloaded, skip the play of the advertisement.

Some embodiments of the present invention are described above. It is to be noted that the present invention is not limited to the above-mentioned embodiments. Those skilled in the art could able to make variations and modifications according to the disclosures herein.

1. A method of providing an electronic program guide from a content server to user equipments, comprising:
a. obtaining titles and playtime of a first number of multimedia contents;
b. generating an electronic program guide including the titles and the playtime of the first number of multimedia contents; and
c. sending the electronic program guide to the user equipments.

2. The method according to claim 1, further comprises:
a. determining if there is an on-demand content corresponding to one or more live-like contents, wherein the one or more live-like contents is included in the multimedia contents; and
b. obtaining an addressing information of the on-demand content if there is the on-demand content corresponding to the live-like contents;
wherein the generated electronic program guide includes the obtained addressing information of the on-demand contents and the live-like contents include a live content or an looping content.

3. The method according to claim 1, wherein the generated electronic program guide further includes information related to content details of the first number of multimedia contents, information related to the content details themselves that are capable of being carried by the electric program guide directly, and information related to the content details comprising the addressing information that cannot be carried by the electric program guide directly.

4. The method according to claim 3, wherein the content details include at least one of the following:
a. picture information obtained by taking the content at one or more time points of every multimedia content;
b. audio section information obtained by taking the content in at least one time slice of every multimedia content;
c. video section information obtained by taking the content in at least one time slice of every multimedia content; and
d. literal description of the content at one or more time point of the multimedia content or in at least one time slice of the multimedia content.

5. A method of using a multimedia server assisting a content server in providing an electric program guide to user equipments, comprising providing the content server with one or more titles and playtime of at least one multimedia content.

6. The method according to claim 5, further comprising providing the content server with content details of the at least one multimedia content, wherein the content details include at least one of the following:
i. picture information obtained by taking the content at one or more time points of every multimedia content;
ii. audio section information obtained by taking the content in at least one time slice of every multimedia content;
iii. video section information obtained by taking the content in at least one time slice of every multimedia content; and
iv. literal description of the content at one or more time point of the multimedia content or in at least one time slice of the multimedia content.

7. The method according to claim 5, further comprising:
providing the content server with classification information of at least one of the multimedia content, the classification information of each multimedia content indicating that the multimedia content belongs to on-demand content looping content or live content.

8. A device for using a content server providing an electric program guide to user equipments, comprising:
a. a first unit configured to obtain titles and playtime of a first number of multimedia contents;
b. a first generating unit configured to generate an electric program guide including the titles and playtime of the first number of multimedia contents;
c. a first transmitter configured to send the electric program guide to the user equipments.

9. A first means The device according to claim 8, further comprises:
a. a first determining unit configured to determine if there is an on-demand content corresponding to one or more live-like contents, wherein the live-content is included in the first number of multimedia contents;
b. a second unit configured to obtain the addressing information of the on-demand content corresponding to the live-like content, wherein the electronic program guide generated by the first generating unit further includes all of the obtained addressing information of the on-demand contents.

10. The device according to claim 8, wherein the electronic program guide generated by the first generating unit further includes information related to content details of the first number of multimedia contents, information related to content details themselves capable of being carried by the electric program guide directly, and information related to content details comprising addressing information which is not able to be carried by the electric program guide directly.

11. A first means The device according to claim 10, wherein the content details include at least one of the followings:
a. picture information obtained by taking the content at one or more time points of every multimedia content;
b. audio section information obtained by taking the content in at least one time slice of every multimedia content;
c. video section information obtained by taking the content in at least one time slice of every multimedia content; and
d. literal description of the content at one or more time point of the multimedia content or in at least one time slice of the multimedia content.

12. A multimedia server for assisting a content server in providing an electric program guide to user equipments, comprising: a unit configured to provide a content server with the title and playtime of at least one multimedia content.

13. The multimedia server according to claim 12, wherein the unit is configured to provide the content server with the content details of the at least one multimedia content, wherein the content details include at least one of the following:
i. picture information obtained by taking the content at one or more time points of every multimedia content;
ii. audio section information obtained by taking the content in at least one time slice of every multimedia content;
video section information obtained by taking the content in at least one time slice of every multimedia content; and
iv. literal description of the content at one or more time point of the multimedia content or in at least one time slice of the multimedia content.

14. The multimedia server according to claim 13, wherein the unit is further configured to provide the content server with classification information of the at least one multimedia content, the classification information of each multimedia content indicating that the multimedia content belongs to on-demand content, looping content, or live content.

15. The multimedia server according to claim 14, further comprising a network server

16. A method of using an advertising server; posting advertisement, comprising:
a. determining a set of advertisements corresponding to each of multimedia contents according to respective characteristic of the multimedia contents;
b. receiving a multimedia content request from a user equipment;
c. analyzing the multimedia content request in order to determine the multimedia content requested by the multimedia content request;
d. inquiring a set of advertisements corresponding to the requested multimedia content;
e. instructing the user equipment to play at least one advertisement among the set of advertisements according to a preset rule.

17. The method according to claim 16, wherein different sets of advertisements are determined for different multimedia contents.

18. The method according to claim 16, further comprising
a. determining a subset of advertisements corresponding to a user group;
b. determining the user group to which the user equipment belongs;
c. searching, in the set of advertisements, for the subset of advertisements corresponding to the user group which the user equipment belongs to;
d. indicating the user equipment to play at least one of the advertisements in the subset according to a preset rule.

19. The method according to claim 16, further comprising:
a. determining a number of advertisements;
b. receiving an advertisement pre-download request from a user equipment; and
c. assisting the user equipment in pre-downloading the number of advertisements.

20. A method of presenting an advertisement, comprising steps of:
a. generating a multimedia content request used to request for a multimedia content;
b. sending the multimedia content request to an advertising server; and
c. playing at least one advertisement corresponding to said multimedia content based on instructions from the advertising server.

21. The method according to claim 20, further comprising:
a. determining whether a preset condition is satisfied;
b. sending an advertisement pre-download request to the advertising server if the preset condition is satisfied; and
c. pre-downloading a number of advertisements predetermined by the advertising server with the aid of the advertising server.

22. The method according to claim 21, wherein the pre-downloading further comprises:
a. monitoring an occupied bandwidth of the user equipment; and
b. dynamically adjusting the bandwidth occupied by pre-downloading the number of advertisements according to the occupied bandwidth of the user equipment.

23. The method according to claim 21, wherein the determining whether a preset condition is satisfied comprises: determining whether any of the following conditions has been satisfied:
a. the user equipment connects to the network; and
b. the user equipment starts to run a particular application program.

24. The method according to claim 21, wherein the playing at least one advertisement further comprises:
determining whether the advertisement has been completely downloaded when an advertisement is needed to be played according to the preset rule; and
skipping the play of the advertisement if the advertisement has not been completely downloaded.

25. A device for posting advertisement, comprising:
a. a first unit configured to determine a set of advertisements corresponding to each of the at least one multimedia content according to respective characteristic of at least one multimedia content;
b. a receiver configured to receive a multimedia content request from a user equipment;
c. a second unit configured to analyze said multimedia content request in order to determine the multimedia content requested by the multimedia content request;
d. an inquiry unit configured to inquire about a set of advertisements corresponding to the requested multimedia content;
e. a third unit configured to instruct the user equipment to play at least one advertisement among the set of advertisements according to a preset rule.

26. The device according to claim 25, wherein sets of advertisements are different for different multimedia contents.

27. The device according to claim 25, wherein the first unit is further configured to:
determine a subset of advertisements corresponding to the user group; and
wherein the second unit is further configured to determine the user group to which the user equipment belongs;
wherein the inquiry unit is further configured to search, in the set of advertisements, for the subset of advertisements corresponding to the user group which a user equipment belongs to; wherein
the third unit is further configured to indicate the user equipment to play at least one of the advertisements in the subset according to a preset rule.

28. The device according to claim 25, further comprising:
a fourth unit configured to determine a number of advertisements;
wherein the receiver is further configured to receive an advertisement pre-download request from a user equipment; and
an fifth unit configured to assist the user equipment in downloading the number of advertisements.

29. A device for presenting an advertisement, comprising:
a. a generating unit configured to generate a multimedia content request used to request for a multimedia content;
b. a transmitter configured to send the multimedia content request to an advertising server; and
c. a player configured to play at least one advertisement corresponding to said multimedia content based on instructions from said advertising server.

30. The device according to claim 29, further comprising:
a. a first determining unit configured to determine whether a preset condition is satisfied; wherein the transmitter is further configured to send an advertisement pre-download request to the advertising server if the preset condition is satisfied; and
b. a downloader configured to pre-downloading a number of advertisements predetermined by the advertising server with the aid of the advertising server.

31. The device according to claim 30, further comprising:
a. a monitor configured to monitor an occupied bandwidth of the user equipment; and
b. an adjustment unit configured to dynamically adjust the bandwidth occupied by pre-downloading the third number of advertisements according to the occupied bandwidth of the user equipment.

32. The device according to claim 30, wherein the first determining unit is further configured to determine that the preset condition is satisfied when any of the following conditions has been satisfied:
a. the user equipment connects to the network; and
b. the user equipment starts to run a particular application program.

33. The device according to claim 30, wherein the player further comprises:
a second determining means unit configured to determine whether the advertisement has been completely downloaded when an advertisement is needed to be played according to the preset rule; and
wherein the player is further configured to skip the play of the advertisement if the advertisement has not been completely downloaded.

34. The device according to claim 25 further comprises an advertising server.

35. (canceled)
